(19) United States
(12) Patent Application Publication
(10) Pub. No.: US 2010/0026189 A1
(43) Pub. Date: Feb. 4, 2010

(54) LAMP DRIVING CIRCUIT, AND DETECTION CIRCUIT FOR DETECTING AN END-OF-LIFE CONDITION

(75) Inventors: Jozef Petrus Emanuel De Krijger, Eindhoven (NL); Marcel Johannes Maria Bucks, Eindhoven (NL); Ferdinand Johannes Petrus Marinus Seuren, Eindhoven (NL); Engbert Bernard Gerard Nijhof, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/444,711

(22) PCT Filed: Oct. 8, 2007
(86) PCT No.: PCT/IB07/54085

§ 371 Date: Apr. 8, 2009

(30) Foreign Application Priority Data
Oct. 12, 2006 (EP) 06122183.4
Feb. 6, 2007 (EP) 07101805.5

(51) Int. Cl. H05B 41/36

(52) U.S. Cl. 315/129; 315/224; 315/219

(57) ABSTRACT

A lamp driving circuit (110) for driving a gas discharge lamp (11) is described, comprising current generating means (M1, M2, D1, D2, L, C, C1, C2) for generating a lamp current in discontinuous mode or critical discontinuous mode, and a controller (12) for controlling the operation of the current generating means. In an embodiment, the current generating means have HBCF topology. A zero-crossings detector (120) detects zero-crossings of the lamp current, and generates a detection pulse for each detected zero-crossing. A signal processor (130) monitors the detection pulses from the zero-crossings detector (120), and generates a lamp current inhibit signal if the detection pulses are absent during at least a predetermined time interval. The controller, in response to the lamp current inhibit signal, switches off the lamp current generating means.

### FIELD OF THE INVENTION

The present invention relates in general to the field of operating gas discharge lamps, specifically HID-lamps. Particularly, the present invention relates to a driving circuit for driving a gas discharge lamp, the driving circuit having a half-bridge configuration, such as a half-bridge converter or a half-bridge commutating forward converter (HBCF).

### BACKGROUND OF THE INVENTION

Gas discharge lamps are known in the art, so an elaborate explanation of gas discharge lamps is not needed here. Suffice it to say that a gas discharge lamp comprises two electrodes located in a closed vessel filled with an ionizable gas or vapor. The vessel is typically quartz or a ceramic, specifically polychrystalline alumina (PCA). The electrodes are arranged at a certain distance from each other, and during operation an electric arc is maintained between those electrodes.

It is common practice to operate a discharge lamp with commutating DC current, i.e. a lamp current which has constant magnitude but alternating direction. A common driver design is a half-bridge circuit. Such design is generally illustrated in FIG. 1, which is a block diagram of an exemplary lamp driver 10 for driving a gas discharge lamp 11 in accordance with prior art. Since such half-bridge circuit topology should be known to persons skilled in the art, the design and functioning will be described only briefly. Two switches M1 and M2 are arranged in series, with corresponding diodes D1, D2, between two voltage rails coupled to a source of substantially constant voltage V. The design of this voltage source is not relevant for the present invention. Two capacitors C1 and C2 are also arranged in series between the two voltage rails. The lamp 11 is coupled between on the one hand the junction between the two switches M1 and M2 and on the other hand the junction between the two capacitors C1 and C2, with an inductor L arranged in series with the lamp 11 and a capacitor C arranged in parallel with the lamp 11. The two switches M1 and M2 are controlled alternately by a controller 12, such that they are never closed (i.e. conductive) at the same time. The two capacitors C1 and C2 have relatively high capacitive values, and the switching frequency of the two switches M1 and M2 is relatively high, so that the voltage at the junction between the two capacitors C1 and C2 is virtually constant.

The operation during steady state (i.e. after ignition) is as follows. In a first switching mode, the upper switch M1 is switched open and closed at a certain switching frequency (active switch), the lower switch M2 is open (i.e. non-conductive, non-active switch). In a second switching mode, the upper switch M1 is open (non-active switch), the lower switch M2 is switched open and closed at the switching frequency (active switch). In the first switching mode, the lamp current I is a substantially triangular wave having an average magnitude, a minimum magnitude and a maximum magnitude. In the second mode, a similar explanation applies, and again the lamp current is a substantially triangular wave having an average magnitude, a minimum magnitude and a maximum magnitude, but the direction of the lamp current is opposite to the direction of the lamp current in the first mode. The circuit is successively in its first and second switching mode; switching from the first switching mode and back is done at a commutation frequency, which is lower than the switching frequency. Control is such that the current wave form is symmetrical with respect to zero. A full current cycle contains the combination of one first switching mode and one second switching mode.

In some modes of operation, the difference between maximum magnitude and minimum magnitude is controlled to be small, so that the current can be described as being substantially constant with a small ripple. It is also possible that the ripple amplitude is larger; in any case, as long as the current between commutation moments has a constant direction, this is called continuous mode. It is also possible that the minimum magnitude is equal to zero, i.e. the current decreases to zero and then increases again; this is called critical discontinuous mode. This mode can be effected by monitoring the current level and rendering the active switch conductive on detection of a zero-crossing of the current.

The above describes the normal operation during steady state. In such normal operation, each of the switches is conductive during a certain time interval and is non-conductive during a certain time interval. The duration of these intervals depend on circumstances, and may even vary somewhat. However, there is a maximum to the duration of these intervals. In order to facilitate initiation of the switching cycle and in order to prevent damage caused by the current flowing in the same direction for too long a time, the circuit is provided with a time control facility: if the active switch is conductive or non-conductive for a time interval that exceeds a predetermined threshold duration, the active switch is switched anyway from conductive to non-conductive or from non-conductive to conductive, as the case may be.

When a discharge lamp reaches the end of its life, different phenomena may occur, such as for instance rectifying modes of operation, and such phenomena may succeed each other in a chaotic manner, depending on lamp parameters such as filling pressure, for instance. Such operation is undesirable, for instance because it may lead to overheating of the lamp, but also because it may lead to variations in the light output. Further, the bridge circuit itself can be destroyed, particularly the switches M1 and M2, if the voltage drops across the switches are too high causing high reverse recovery currents to be drawn from the body diode of the non-active switch. Therefore, it is desirable to have a detection circuit capable of detecting whether the lamp is in an end-of-life mode, such as to generate an early warning against the approaching end of the lifetime of the lamp concerned, such that appropriate measures can be taken, such as for instance the driver automatically switching off.

It appears that it is difficult to reliably detect end-of-life operation in an accurate and fast manner. U.S. Pat. No. 5,808,422 discloses a detection circuit comprising a measuring capacity, which is charged in case there is an unbalance in the lamp current, such as occurs when the lamp is operating in a rectifying mode.

The present invention aims to provide a different type of detection circuit, operating according to a different detection principle.

### SUMMARY OF THE INVENTION

When operating in an end-of-life mode, the rectifying effect of the asymmetric current behavior leads to a deviation of the voltage at the node between the two capacitors C1 and C2. As a result, large LF currents flow through inductor L, offsetting the HF current. As a result, the time for the current to reach the zero level becomes larger than said predetermined threshold duration, so that the active switch is switched using time-control. Consequently, contrary to the intended mode of operation, the zero current level is temporarily not reached.

According to an important aspect of the present invention, this effect is used. Particularly, the present invention proposes to provide the lamp driving circuit with a zero-crossing detector, generating a detection pulse each time a zero-crossing of the lamp current is detected, and to utilize the absence of such zero-crossing detection signals as indicating the occurrence of an end-of-life mode.

Further advantageous elaborations are mentioned in the dependent claims.

### BRIEF DESCRIPTION OF THE DRAWINGS

These and other aspects, features and advantages of the present invention will be further explained by the following description of one or more preferred embodiments with reference to the drawings, in which same reference numerals indicate same or similar parts, and in which:

FIG. 1 is a block diagram schematically showing a lamp driver circuit according to prior art;

FIG. 2 is a graph illustrating lamp current in an end-of-life mode;

FIG. 3 is a block diagram schematically showing an embodiment of a lamp driver circuit according to the present invention;

FIG. 4 is a block diagram schematically illustrating details of an exemplary embodiment of a detector for detecting absence of zero-crossing signals.

### DETAILED DESCRIPTION OF THE INVENTION

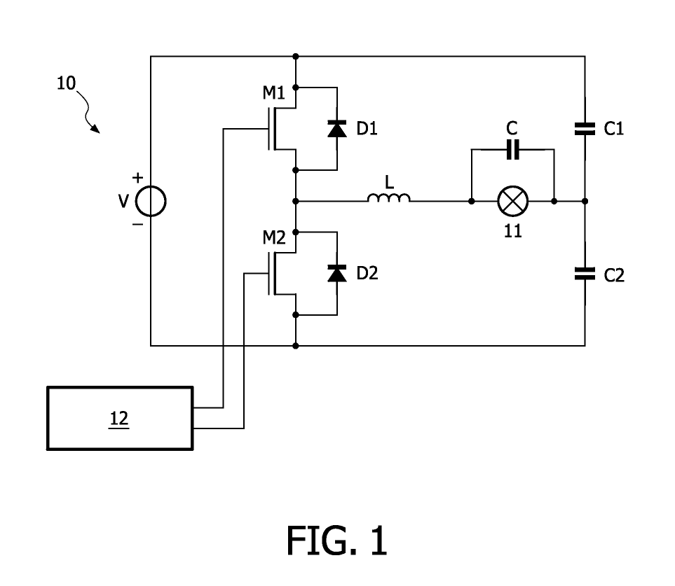

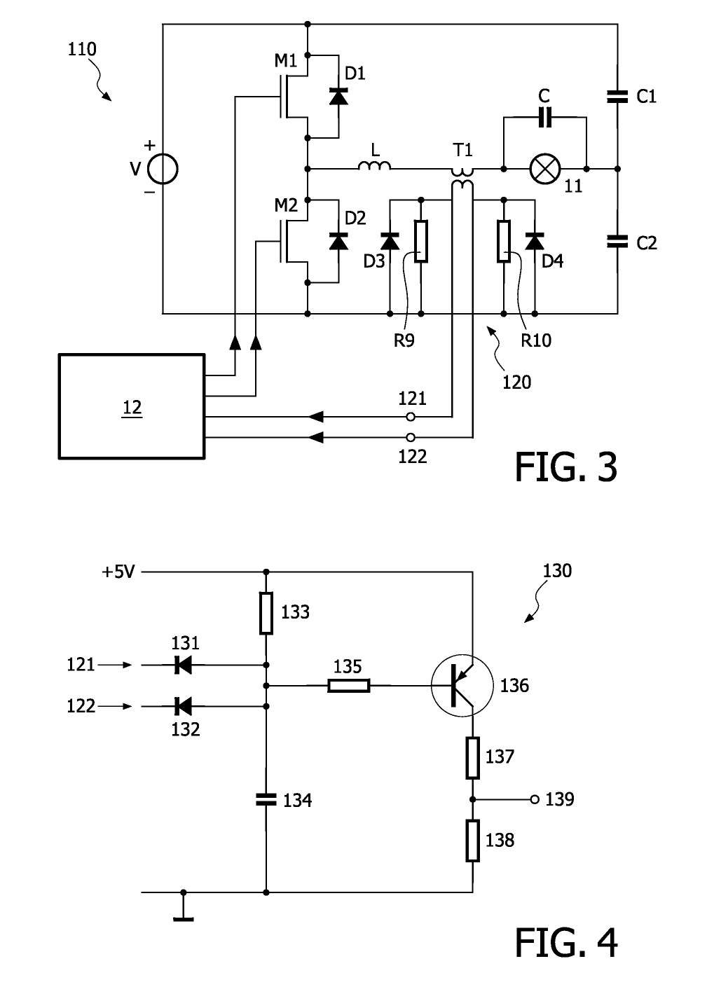

FIG. 3 is a block diagram schematically showing an embodiment of a lamp driver circuit 110 according to the present invention. This circuit 110 is similar to the circuit 10 of FIG. 1, with the exception of a zero-crossing detector 120 being added, capable of detecting when the lamp current reaches zero, and having output terminals 121, 122 coupled to the controller 12.

Zero-crossing detectors are known per se, and the present invention can be implemented with any kind of zero-crossing detector (ZCD). In the embodiment of FIG. 3, the ZCD is implemented as a small transformer T1 having a small number of turns per winding, having its primary winding connected in series with the lamp 11 and the inductor L. A first end terminal of the secondary winding is connected to the negative supply terminal via a parallel arrangement of a third diode D3 and a first resistor R9. The opposite second end terminal of the secondary winding is connected to the negative supply terminal via a parallel arrangement of a fourth diode D4 and a second resistor R10. As long as the lamp current is relatively large, the transformer T1 is saturated and does not provide an output sensing signal: both end terminals are at the same potential via the resistors R9 and R10. Only when the lamp current is very low, almost equal to zero, the transformer T1 is not saturated and provides an output current. The direction of this output current depends on the direction of the lamp current in the primary winding (i.e. the sign of I), and on whether the lamp current is increasing or decreasing (i.e. the sign of dl/dt). Depending on the direction of the output current in the secondary winding, a negative voltage will develop over one of the resistors R9, R10, thus the output detection signal will be a negative voltage pulse at one of the output terminals 121, 122.

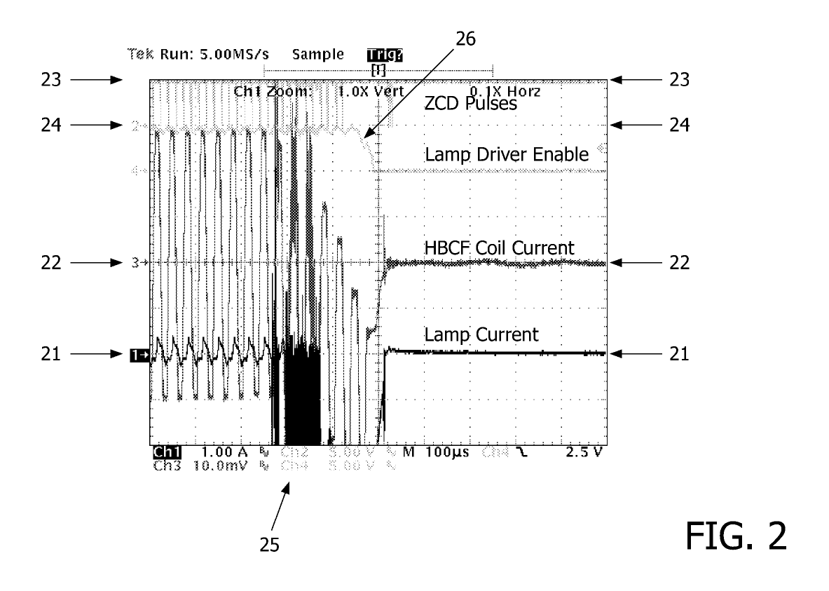

FIG. 2 is a graph illustrating different signals above each other. A first curve 21 shows lamp current; at the lefthand side of the graph, this curve has a substantially triangular shape with a top-top amplitude of about half a division, corresponding to about 0.5 A.

A second curve 22 shows the current in the inductor L. At the lefthand side of the graph, this curve has a top-top amplitude of about 6 divisions, corresponding to about 12 A. The arrow at reference numeral 22 points at the zero level of the inductor current: it can be seen that the inductor current crosses zero at regular intervals.

A third curve 23 shows the output detection signal of the ZCD 120. Normally, this signal has a voltage level of 5 V (coinciding with the top border of the graph), and at each zero-crossing the output detection signal shows a pulse of zero volts, corresponding to a negative pulse of one division amplitude.

The FIG. 2 further shows a phenomenon associated with end-of-life, indicated at 25. The inductor current becomes offset (to the bottom side of the graph), and after about 5 current periods the current does not cross zero any more. The lamp current becomes erratic, and disappears from sight below the lower border of the graph. The negative pulses of the output detection signal of the ZCD 120 disappear.

The controller 12 receives the output signal from the ZCD 120, and on the basis of this output signal the controller 12 decides to switch off the lamp by generating control signals for the switches M1 and M2 for placing both switches M1 and M2 in their non-conductive state, so that no lamp current can flow any more. An exemplary processing circuit 130 for processing the output signals of the exemplary ZCD 120 of FIG. 3, such as to reliably detect absence of zero-crossing detection pulses, is illustrated in FIG. 4, which processing circuit 130 may be integrated in the controller 12 but which also may be a separate circuit arranged between the ZCD 120 and the controller 12.

The processing circuit 130 comprises a series arrangement of a resistor 133 and a capacitor 134 arranged between a positive voltage terminal (for instance 5 V) and zero voltage. The processing circuit 130 further comprises a PNP transistor 136 having its emitter connected to the positive voltage terminal, and having its collector coupled to the zero voltage via a series arrangement of two resistors 137, 138. The processing circuit 130 further comprises two diodes 131, 132 having their cathodes connected to the output terminals 121, 122, respectively, of the ZCD 120, and having their anodes connected to the node between said resistor 133 and capacitor 134, which node is coupled to the gate of the transistor 136 via a resistor 135. An output terminal 139 of the circuit 130 is connected to the node between resistors 137 and 138. FIG. 2 also shows the output signal at this output terminal 139 (curve 24).

The operation of the processing circuit 130 is as follows.

Capacitor 134 tends to be charged through resistor 133. Whenever an output pulse is received from the ZCD 120, be it via diode 131 or via diode 132, capacitor 134 is discharged. Thus, as long as zero-crossings occur, the voltage level at said node between resistor 133 and capacitor 134 will remain relatively low, transistor 136 is conducting, and the voltage at the output terminal 139 is high, this voltage depending on the resistance ratio of resistors 137 and 138. In the embodiment shown, this voltage has a value of about 5 V (indicated by arrow 24 at the lefthand side of the graph; it can be seen here that the signal has an amplitude of about one-tenth of a division), corresponding to one division. At the righthand side of the graph, arrow 24 indicates the zero level of this voltage.

When ZCD 120 does not generate output pulses, the voltage level at said node between resistor 133 and capacitor 134 keeps rising. At a certain moment, this voltage level is so high that transistor 136 stops conducting, and the voltage at the output terminal 139 drops to zero: this portion of curve 24 is indicated at 26. In response to this, the controller 12 sets both switches M1 and M2 in their non-conductive state and stops the switching of the switches M1 and M2, so that effectively the driver 110 is switched off. At the righthand side of the graph, the curves 21 and 22 are now zero.

The time needed for the voltage level of capacitor 134 to rise sufficiently such as to render transistor 136 non-conductive depends on the RC-time constant defined by the resistance value of resistor 133 and the capacitance value of capacitor 134, as should be clear to a person skilled in the art. The longer this time, the more “missing” zero-crossings are needed for the driver 110 to stop operating. In a suitable embodiment, said RC-time constant is about five times the lowest switching period, i.e. the smallest time interval expected between successive zero-crossings.

Summarizing, the present invention provides a lamp driving circuit 110 for driving a gas discharge lamp 11, comprising current generating means M1, M2, D1, D2, L, C, C1, C2 for generating a lamp current in discontinuous mode or critical discontinuous mode, and a controller 12 for controlling the operation of the current generating means. In an embodiment, the current generating means have HBCF topology.

A zero-crossings detector 120 detects zero-crossings of the lamp current, and generates a detection pulse for each detected zero-crossing.

A signal processor 130 monitors the detection pulses from the zero-crossings detector 120, and generates a lamp current inhibit signal if the detection pulses are absent during at least a predetermined time interval.

The controller, in response to the lamp current inhibit signal, switches off the lamp current generating means.

While the invention has been illustrated and described in detail in the drawings and foregoing description, it should be clear to a person skilled in the art that such illustration and description are to be considered illustrative or exemplary and not restrictive. The invention is not limited to the disclosed embodiments; rather, several variations and modifications are possible within the protective scope of the invention as defined in the appending claims.

For instance, a different type of ZCD may be used. Also, in stead of negative detection pulses, a ZCD may provide positive pulses, and the processing circuit 130 should be suitable adapted.

Further, the invention is not restricted to lamp drivers of the HBCF design.

Further, it is possible that the lamp is operated in discontinuous mode, in which case zero-crossings also occur between commutation moments.

Further, for implementing the invention it is immaterial whether the circuit is operating in ignition mode or in steady state mode.

Further, the output signal of the processing circuit 130 may be considered as being an inhibit signal for inhibiting lamp operation, the controller 12 switching off the lamp current in response to the inhibit signal. It is also possible that the combination of ZCD 120 and processing circuit 130 is considered as being a detector for indicating an end-of-life condition, and that the output signal of the processing circuit 130 is considered as being an indication signal indicating the detected end-of-life condition. Instead of switching off the lamp current, a different action may be taken in response.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Lamp driving circuit (110) for driving a gas discharge lamp (11), comprising: current generating means (M1, M2, D1, D2, L, C, C1, C2) for generating a lamp current in discontinuous mode or critical discontinuous mode, and a controller (12) for controlling the operation of the current generating means (M1, M2, D1, D2, L, C, C1, C2);
a zero-crossings detector (120) arranged for detecting zero-crossings of the lamp current and for generating a detection pulse in response to detecting a zero-crossing of the lamp current;
a signal processor (130) for monitoring the detection pulses from the zero-crossings detector (120) and for generating a lamp current inhibit signal in response to detecting that detection pulses are absent during at least a predetermined time interval; wherein the controller (12), in response to the lamp current inhibit signal, is designed to switch off the lamp current generating means (M1, M2, D1, D2, L, C, C1, C2).

2. Lamp driving circuit according to claim 1, wherein the current generating means have a half-bridge topology comprising two switches (M1, M2) arranged in series between two voltage rails, the switches being controlled by the controller (12); and wherein the controller (12), in response to the lamp current inhibit signal, is designed to switch both switches (M1, M2) to their non-conductive states.

3. Lamp driving circuit according to claim 1, wherein the zero-crossings detector (120) comprises a saturable transformer (T1) having its primary winding arranged in series with the lamp (11), which transformer is dimensioned such as to be saturated as long as the lamp current has a magnitude above a pre-determined threshold level.

4. Lamp driving circuit according to claim 1, wherein the signal processor (130) has an output terminal (139) providing an output signal having a first level if successive detection pulses from the zero-crossings detector (120) are received with a mutual time distance smaller than a predetermined threshold, and providing the output signal having a second level differing from the first level of no detection pulses from the zero-crossings detector (120) are received during at least said predetermined threshold time.

5. Lamp driving circuit according to claim 4, wherein said predetermined threshold time is in the order of about five times the expected time distance between successive zero-crossings during normal steady-state lamp operation.

6. Lamp driving circuit according to claim 1, wherein the signal processor (130) comprises a capacitor (134) which is constantly charged through a resistor (133) and which is discharged by the detection pulses from the zero-crossings detector (120), and wherein the signal processor (130) comprises a switch (136) having a control terminal coupled to the said capacitor (134), so that the switching state of the switch (136) is determined by the voltage over the said capacitor (134).

7. Detection circuit for detecting an end-of-life condition of a gas discharge lamp (11), comprising:
a zero-crossings detector (120) for detecting zero-crossings of the lamp current and for generating a detection pulse in response to detecting a zero-crossing of the lamp current;
a signal processor (130) for monitoring the detection pulses from the zero-crossings detector (120) and for generating an end-of-life condition indicating output signal in response to detecting that detection pulses are absent during at least a predetermined time interval.

8. Detection circuit according to claim 7, wherein the zero-crossings detector (120) comprises a saturable transformer (T1) having a primary winding for receiving lamp current, which transformer is dimensioned such as to be saturated as long as the current in its primary winding has a magnitude above a pre-determined threshold level.

9. Detection circuit according to claim 7, wherein the signal processor (130) has an output terminal (139) providing an output signal having a first level if successive detection pulses from the zero-crossings detector (120) are received with a mutual time distance smaller than a predetermined threshold, and providing the output signal having a second level differing from the first level of no detection pulses from the zero-crossings detector (120) are received during at least said predetermined threshold time.

10. Detection circuit according to claim 7, wherein the signal processor (130) comprises a capacitor (134) which is constantly charged through a resistor (133) and which is discharged by the detection pulses from the zero-crossings detector (120), and wherein the signal processor (130) comprises a switch (136) having a control terminal coupled to the said capacitor (134), so that the switching state of the switch (136) is determined by the voltage over the said capacitor (134).

11. Method for detecting an end-of-life condition of a gas discharge lamp (11), the method comprising the steps of:
detecting zero-crossings of the lamp current;
deciding that the gas discharge lamp (11) is operating in an end-of-life condition if zero-crossings are absent during at least a predetermined time interval.

12. Method according to claim 11, further comprising the step of generating an end-of-life condition indicating output signal in response to detecting that zero-crossings are absent during at least said predetermined time interval.

13. Method according to claim 11, further comprising the step of switching off the lamp in response to detecting that zero-crossings are absent during at least said predetermined time interval.

14. Method according to claim 11, further comprising the steps of continuously charging a capacitor (134) and discharging the capacitor in response to detecting a zero-crossing of the lamp current;
deciding that the gas discharge lamp (11) is operating in an end-of-life condition if the voltage over the capacitor reaches a predetermined threshold level.
